(19) United States
(12) Patent Application Publication
(10) Pub. No.: US 2011/0126401 A1
(43) Pub. Date: Jun. 2, 2011

(54) HEAT-RESISTANT NONWOVEN FABRIC

(76) Inventors: Takahiro TSUKUDA, Tokyo (JP); Masatoshi Midorikawa, Tokyo (JP)

(21) Appl. No.: 13/022,890

(22) Filed: Feb. 8, 2011

Related U.S. Application Data
(62) Division of application No. 10/592,315, filed on Sep. 18, 2009.

(30) Foreign Application Priority Data
Mar. 12, 2004 (JP) 2004-070544
Mar. 12, 2004 (JP) 2004-070545

(51) Int. Cl. H01M 6/00

(52) U.S. Cl. 29/623.1

(57) ABSTRACT

The present invention discloses a heat-resistant nonwoven fabric comprising a layer having heat resistance property and a layer having anti-oxidative property, wherein the heat-resistant nonwoven fabric has a puncture strength of 0.5 N or more after heat treatment at 250° C. for 50 hours; and a position of an absorption band (A) showing a maximum infrared absorbance in the region of 500 cm⁻¹ to 3000 cm⁻¹ of the layer having an anti-oxidative property does not change before and after applying a voltage of 2.7V for 72 hours, and

an absolute value of a rate of change ((C−D)/C) is less than 25%,

wherein

(C) is a ratio of an absorbance at the absorption band (A) before applying the voltage to an absorbance at a wave number (B) before applying the voltage, and

(D) is a ratio of an absorbance at the absorption band (A) after applying the voltage to an absorbance at a wave number (B) after applying the voltage,

wherein the wave number (B) is a wave number of independent absorption peaks other than an absorption peak branched from the absorption band (A) or a shoulder peak,
successively selected from a wave number of an independent absorption peak having a larger absorbance among the group of said independent absorption peaks.

### CROSS REFERENCE

The present application is a 37 C.F.R. §1.53(b) divisional of, and claims 35 U.S.C. §120 priority to, U.S. application Ser. No. 10/592,315, filed Sep. 11, 2006. Application Ser. No. 10/592,315 is the national phase under 35 U.S.C. §371 of International Application No. PCT/JP2005/004319, filed on Mar. 11, 2005. Priority is also claimed to Japanese Application No. 2004-070544 filed on Mar. 12, 2004 and Japanese Application No. 2004-070545 filed on Mar. 12, 2004. The entire contents of each of these applications is hereby incorporated by reference.

### TECHNICAL FIELD

The present invention relates to a heat-resistant nonwoven fabric having anti-oxidative property.

### BACKGROUND ART

In recent years, as one of characteristics required for an electrochemical element, there may be mentioned heat resistance such as reflow heat resistance, etc. Therefore, for a nonwoven fabric incorporated into the electrochemical element, a nonwoven fabric excellent in heat resistance is employed. Such an electrochemical element having a heat-resistant nonwoven fabric incorporated may include, for example, an electrolytic capacitor using a separator which comprises an aromatic polyamide fiber (for example, see Patent Literatures 1 and 2), an electrolytic capacitor using a separator comprising polyamide fibers as a main fiber (for example, see Patent Literature 3) and the like.

However, among the electrochemical elements, when a high-voltage electrochemical element such as a lithium ion battery, an electric double layer capacitor, an electrolytic capacitor, etc. is used, potent oxidative power is generated at the positive electrode side. Thus, there is a problem that the lifetime of the electrochemical element is shortened if a separator comprising an aromatic polyamide or an aliphatic polyamide which is likely oxidized and deteriorated is used in the element.
[Patent Literature 1] Japanese Unexamined Patent Publication No. Hei.1-278713
[Patent Literature 2] Japanese Unexamined Patent Publication No. Hei.2-20012
[Patent Literature 3] Japanese Unexamined Patent Publication No. 2002-198263

### DISCLOSURE OF THE INVENTION

### Problems to be Solved by the Invention

An object of the present invention is to provide a heat-resistant nonwoven fabric excellent in anti-oxidative property.

### Means to Solve the Problems

The present inventors have carried out extensive studies to solve the problem, and as a result, they have found that a heat-resistant nonwoven fabric excellent in anti-oxidative property can be obtained by integrating a layer having heat resistance and a layer having an anti-oxidative property, whereby they have accomplished the present invention.

That is, the heat-resistant nonwoven fabric of the present invention comprises a layer having heat resistance property and a layer having anti-oxidative property, wherein the heat-resistant nonwoven fabric has a puncture strength of 0.5N or more after heat treatment at 250° C. for 50 hours; and a position of an absorption band (A) showing a maximum infrared absorbance in the region of 500 cm⁻¹ to 3000 cm⁻¹ of the layer having an anti-oxidative property does not change before and after applying a voltage of 2.7V for 72 hours, and

an absolute value of a rate of change ((C−D)/C) is less than 25%,

wherein

(C) is a ratio of an absorbance at the absorption band (A) before applying the voltage to an absorbance at a wave number (B) before applying the voltage, and

(D) is a ratio of an absorbance at the absorption band (A) after applying the voltage to an absorbance at a wave number (B) after applying the voltage,

wherein the wave number (B) is a wave number of independent absorption peaks other than an absorption peak branched from the absorption band (A) or a shoulder peak, successively selected from a wave number of an independent absorption peak having a larger absorbance among the group of said independent absorption peaks.

In the present invention, at least the layer having heat resistance property preferably contains heat resistant fiber having a softening point, a melting point and a thermal decomposition temperature all within the range of 250° C. to 700° C.

In the present invention, at least a part of the heat resistant fiber is preferably fibrillated to a fiber diameter of 1 μm or less.

### BEST MODE TO CARRY OUT THE INVENTION

The electrochemical element in the present invention refers to manganese dry battery, alkaline manganese battery, silver oxide battery, lithium battery, lead storage battery, nickel-cadmium storage battery, nickel-hydrogen storage battery, nickel-zinc storage battery, silver oxide-zinc storage battery, lithium ion battery, lithium polymer battery, various kinds of gel electrolyte batteries, zinc-air storage battery, iron-air storage battery, aluminum-air storage battery, fuel battery, solar battery, sodium sulfur battery, polyacene battery, electrolytic capacitor, electric double layer capacitor, etc.

The heat-resistant nonwoven fabric of the present invention has a puncture strength of 0.5N or more after treatment at 250° C. for 50 hours, preferably 0.7N or more, more preferably 0.9N or more. Even when the heat treatment is carried out at a lower temperature than 250° C., it shows the puncture strength of 0.5N or more. The puncture strength in the present invention means a maximum load (N) when a metal needle having a rounded tip and a diameter of 1 mm moves vertically downward to the surface of the heat-resistant nonwoven fabric sample at a constant speed, and then passes through the sample. When the tip of the metal needle is flat or plane, an angle at which the tip contacts the surface of the sample becomes not in the right angle. Furthermore, when the metal needle has burr at the tip, the needle likely passes through the sample, whereby the measured values vary remarkably. Therefore, a metal needle having a rounded tip is used. For the roundness, the curvature is preferably 1 to 2. As a measurement device for measuring puncture strength, commercially available tensile tester or a table type material tester is used. If the puncture strength is less than 0.5N, the heat-resistant nonwoven fabric becomes brittle, and is likely broken or injured with a slight pressure or impact. The puncture strength is preferably 10N or less, more preferably 5N or less. In the case of a heat-resistant nonwoven fabric having the puncture strength of larger than 10N after the heat treatment, a thickness of the fabric sometimes exceeds 300 μm. In such a case, a surface area of the electrode contained in an electrochemical element such as a secondary battery or an electric double layer capacitor, etc., becomes small so that a capacitance of the electrochemical element becomes small.

As a devise for heating the fabric at 250° C., a commercially available thermostatic dryer or electric furnace, etc. may be used. The atmosphere may be any of air atmosphere, an inert gas atmosphere or vacuum atmosphere. An inert gas atmosphere or vacuum atmosphere is preferred since strength reduction or remarkable change in physical properties due to oxidation of the heat-resistant nonwoven fabric is suppressed in such atmospheres. When vacuum atmosphere is selected, the degree of vacuum higher than 10⁻² Torr may be used.

In the present invention, at least the layer having heat resistance property preferably contains a heat resistant fiber having the softening point, the melting point and the thermal decomposition temperature all within the range of 250° C. to 700° C. When a content of the fiber is 20% by weight or more based on the whole heat-resistant nonwoven fabric, then required heat resistance property can be easily obtained.

A softening point, a melting point and a thermal decomposition temperature of the heat resistant fiber to be used in the present invention are preferably 260° C. to 650° C., more preferably 270° C. to 600° C., and most preferably 280° C. to 550° C.

The layer having heat resistance property in the present invention is not specifically limited so long as it is the layer having heat resistance property as mentioned above. A formulation amount of the heat resistant fiber constituting the layer having heat resistance property is preferably 50 to 100% by weight based on the total amount of the layer, more preferably 70 to 100% by weight, and most preferably 80 to 100% by weight.

In the present invention, as the heat resistant fiber having the softening point, the melting point and the thermal decomposition temperature all within the range of 250° C. to 700° C., there may be mentioned wholly aromatic polyamide, wholly aromatic polyester, wholly aromatic polyester amide, wholly aromatic polyether, wholly aromatic polycarbonate, wholly aromatic polyazomethine, polyphenylene sulfide (PPS), poly-p-phenylenebenzobisthiazole (PBZT), polybenzimidazole (PBI), polyether ether ketone (PEEK), polyamideimide (PAI), polyimide, polytetrafluoroethylene (PTFE), poly-p-phenylene-2,6-benzobisoxazole (PBO), etc., and they may be used singly, or in combination of two or more kinds thereof. PBZT may be any of a trans form or a cis form. Here, the phrase “fibers having a softening point, melting point and thermal decomposition temperature all within the range of 250 to 700° C.” may include fibers having thermal decomposition temperature within the range of 250 to 700° C. while having unclear softening point and melting point. A wholly aromatic polyamide or PBO, etc., are an example thereof. Among these fibers, the wholly aromatic polyamide, in particular para series wholly aromatic polyamide, and the wholly aromatic polyester are preferred since they are easily uniformly and narrowly fibrillated due to their liquid crystallinity.

The para series wholly aromatic polyamide may include, but are not limited to, poly(paraphenylenetelephthalamide), poly(parabenzamide), poly(paraamide hydrazide), poly(paraphenylenetelephthalamide-3,4-diphenyl ether telephthalamide), poly-(4,4′-benzanilide telephthalamide), poly(paraphenylene-4,4′-biphenylenedicarboxylic acid amide), poly(paraphenylene-2,6-naphthalene dicarboxylic acid amide), poly(2-chloro-p-phenylenetelephthalamide), copolyparaphenylene-3,4′-oxydiphenylenetelephthalamide, etc. Incidentally, in the para series wholly aromatic polyamide, poly(paraphenylenetelephthalamide) is most preferred.

The wholly aromatic polyester can be synthesized by combining monomers such as an aromatic diol, an aromatic dicarboxylic acid, an aromatic hydroxycarboxylic acid, etc., with changing the monomer composition ratio, etc. For example, an example of the wholly aromatic polyester may include, but is not limited to, a copolymer of p-hydroxybenzoic acid and 2-hydroxy-6-naphthoic acid.

It is preferred that at least part of the heat resistant fiber used in the present invention is fibrillated to a fiber diameter of 1 μm or less (hereinafter referred to as fibrillated fiber or fibrillated heat resistant fiber.). Here, the fibril represents fibers in the fibrous form having a portion that is extremely finely divided in a direction primarily parallel to the fiber axis, wherein at least a portion of the fibers have a fiber diameter of 1 μm or less. The fibril is different from fibrid as clearly described in U.S. Pat. No. 5,833,807 or U.S. Pat. No. 5,026,456 in the preparation process and the shape thereof. An aspect ratio which is a ratio of a length to a width of the fibril in the present invention is preferably distributed in the range of 20:1 to 100000:1. The Canadian Standard Freeness thereof is preferably within the range of 0 ml to 500 ml. Moreover, a weight average fiber length thereof is preferably in the range of 0.1 mm to 2 mm.

The fibrillated fibers in the present invention can be obtained by fibrillation using a refiner, a beater, a mill, a pulverizer, a rotary blade system homogenizer that imparts a shear force with a high-speed rotating blade, a double-cylinder type high speed homogenizer in which a shear force is generated between a cylindrical inner blade rotating at a high-speed and a stationary outer blade, a ultrasonic wave crusher in which a material is fined by an impact of ultrasonic wave, a high-pressure homogenizer applying shearing force and cutting force to fibers by accelerating a fiber suspension by passing through a small diameter orifice while imparting a pressure difference of at least 3000 psi followed by rapidly decelerating by causing collisions between the fibers, and the like. In particular, fibrillated fibers prepared by a high-pressure homogenizer are preferred since finer fibril can be obtained.

The anti-oxidative property in the present invention means the property that the surface of the nonwoven fabric at the positive electrode side is not deteriorated or difficultly deteriorated due to voltage application of 2.7V. Deterioration of the surface of the nonwoven fabric can be judged by changes of an infrared absorption spectrum in the region of 500 cm⁻¹ to 3000 cm⁻¹ before and after applying voltage thereto. In the present invention, the fiber is regard as having an anti-oxidative property when the following requirements are met:

a position of an absorption band (A) showing a maximum infrared absorbance in the region of 500 cm⁻¹ to 3000 cm⁻¹ of the layer having an anti-oxidative property does not change before and after applying a voltage of 2.7V for 72 hours, and

an absolute value of a rate of change ((C−D)/C) is less than 25%,

wherein

(C) is a ratio of an absorbance at the absorption band (A) before applying the voltage to an absorbance at a wave number (B) before applying the voltage, and

(D) is a ratio of an absorbance at the absorption band (A) after applying the voltage to an absorbance at a wave number (B) after applying the voltage. Here, the wave number (B) is a wave number of independent absorption peaks other than an absorption peak branched from the absorption band (A) or a shoulder peak, successively selected from a wave number of an independent absorption peak having a larger absorbance among the group of independent absorption peaks. Further, at the wave number (B), the maximum absolute value of a rate of change ((C−D)/C) in terms of a ratio of absorbances is less than 25%. On the other hand, in the case of a layer not having an anti-oxidative property, although a wave number (B) is also successively selected from a wave number of an independent absorption peak having a larger absorbance among the group of independent absorption peaks other than an absorption peak branched from the absorption band (A) or a shoulder peak, at least one wave number (B), the absolute value of a rate of change ((C−D)/C) is 25% or more. Absorption bands of infrared rays are specific to a chemical bond(s), so that specific infrared absorption spectrum can be obtained for the respective fiber materials which constitute the heat-resistant nonwoven fabric. For example, when the fiber contains a polyester, an absorption band derived from carbonyl C═O stretch appears at around 1950-1600 cm⁻¹; when the fiber contains a polyamide, an absorption band derived from C═O stretch of amide I appears at around 1715-1630 cm⁻¹ and an absorption band derived from C═O stretch of amide II appears at around 1650-1475 cm⁻¹; and when the fiber contains an aliphatic nitrile, an absorption band derived from C N stretch appears at around 2250-2225 cm⁻¹. An absorption band derived from a methylene group of a linear alkane having 7 or less carbon atoms appears at around 720 cm⁻¹, an absorption band of a vinyl group (CH₂═CH—) appears at around 1640 cm⁻¹, and an absorption band of a vinylidene alkene (CH₂═C<) appears at around 1650 cm⁻¹.

For evaluating the anti-oxidative property, a heat-resistant nonwoven fabric comprising a layer having heat resistance and a layer having an anti-oxidative property is sandwiched by two electrodes, and a voltage of 2.7V is applied between the electrodes in an organic electrolyte for 72 hours. An infrared absorption spectrum at the surface of the layer having an anti-oxidative property contacted with the positive electrode side after applying the voltage of 2.7V for 72 hours in an organic electrolyte are compared to an infrared absorption spectrum at the surface of the layer having an anti-oxidative property before applying a voltage to examine the anti-oxidative property. As the electrode, metals such as platinum or aluminum, etc., a carbon such as graphited carbon, carbon, activated carbon, etc. may be used. As for the electrolyte, there may be mentioned, but are not limited to, electrolytes in which an ionizable salt(s) is dissolved in an organic solvent such as propylene carbonate (PC), ethylene carbonate (EC), dimethyl carbonate (DMC), diethyl carbonate (DEC), acetonitrile (AN), γ-butyrolactone (BL), dimethylformamide (DMF), tetrahydrofuran (THF), dimethoxyethane (DME), dimethoxymethane (DMM), sulfolane (SL), dimethylsulfoxide (DMSO), ethylene glycol, propylene glycol, etc., and ionic liquid (solid molten salt), etc.

As the anti-oxidative fiber in the present invention, any fibers may be used so long as it is not oxidized or deteriorated, or difficultly oxidized or deteriorated at the positive electrode side. Examples of the anti-oxidative fiber may include, but are not limited to, fibers comprising, for example, a polyester such as polyethylene terephthalate and polybutylene terephthalate, wholly aromatic polyester, polyolefin, an acryl comprising acrylonitrile or derivatives thereof, PTFE, PEEK, PBZT, PBO, etc., and a modified fiber to which anti-oxidative property is provided. Preferred anti-oxidative fibers are polyethylene terephthalate, polybutylene terephthalate, wholly aromatic polyester, acrylonitrile or derivatives thereof, PTFE, PEEK, PBZT, and PBO. The anti-oxidative fiber may be fibrillated, or may not be fibrillated.

The layer having an anti-oxidative property in the present invention is not specifically limited so long as it is a layer having the anti-oxidative property as mentioned above. A formulation amount of the anti-oxidative fiber constituting the layer having an anti-oxidative property is preferably 50 to 100% by weight, more preferably 70 to 100% by weight, most preferably 80 to 100% by weight based on the total amount of the layer having an anti-oxidative property.

The layer having both of heat resistance and an anti-oxidative property in combination in the present invention may comprises a fiber having both of heat resistance and an anti-oxidative property, wherein a formulation amount of fiber having both of heat resistance and an anti-oxidative property in combination is preferably 20 to 100% by weight, more preferably 50 to 100% by weight, most preferably 70 to 100% by weight based on the whole amount of the layer having both of heat resistance and an anti-oxidative property. The fiber having both of heat resistance and an anti-oxidative property in combination in the present invention may include, but are not limited to, wholly aromatic polyester, PTFE, PEEK, PBZT, PBO, etc.

The heat-resistant nonwoven fabric of the present invention may contain an organic fiber other than the heat resistant fiber and the anti-oxidative fiber. Such an organic fiber may include monofilament fiber or composite fiber comprising aliphatic polyamide, polyether sulfone (PES), polyvinylidene fluoride (PVDF), polyvinyl alcohol, ethylene-(vinyl acetate)-vinyl alcohol copolymer, natural fiber, regenerated cellulose, solvent spinning cellulose (lyocell), etc.

A fiber length of these organic fibers is preferably 0.1 mm to 15 mm, more preferably 1 mm to 10 mm. If the fiber length is shorter than 0.1 mm, the fiber is easily dropped, while if it is longer than 15 mm, the fiber gets entangled to easily cause mass, and unevenness in thickness is likely caused in some cases. An average fiber diameter of these non-fibrillated fibers is preferably in the range of 0.0002 μm to 30 μm, more preferably 0.01 μm to 20 μm. A fineness is preferably in the range of 0.0001 dtex to 3 dtex, more preferably 0.005 dtex to 2 dtex. If the average fiber diameter is less than 0.01 μm, in particular if it is less than 0.0002 μm, or if the fineness is less than 0.005 dtex, in particular if it is less than 0.0001 dtex, the fiber is too fine so that it is difficult to capture the fibrillated heat resistant fiber and the fibrillated cellulose, whereby a basic skeleton of the wet nonwoven fabric is difficultly formed in some cases. If the average fiber diameter is thicker than 20 μm, in particular if it is thicker than 30 μm, or if the fineness is thicker than 2 dtex, in particular if it is thicker than 3 dtex, the fibrillated heat resistant fiber and the fibrillated cellulose may be easily dropped, and as a result, pin holes are likely generated, and texture formation may become uneven in some cases.

A sectional shape of the non-fibrillated fiber to be used in the present invention may be any of circular, ellipse shape, square, rectangular, star shape, Y shape, or any other different shapes.

The heat-resistant nonwoven fabric of the present invention comprises a layer having heat resistance and a layer having an anti-oxidative property. At this time, the phrase “layer having an anti-oxidative property” may also include a layer having both of heat resistance and an anti-oxidative property in combination. These layers may be any of wet nonwoven fabric or dry nonwoven fabric. As a preparation method of the heat-resistant nonwoven fabric of the present invention, there may be mentioned the following methods: a method of combining a layer having heat resistance and a layer having an anti-oxidative property according to a wet paper making process using a plural number of wire cloth; a method of papermaking a plural number of layers on one wire cloth according to the wet paper making process; a method of thermally adhering the layers; a method of adhering the layers with a resin; and a method of interlacing the layers with water-flow; and the like. From the viewpoints of uniformity, interlayer strength, and production efficiency, it is preferred to produce a nonwoven fabric by the wet paper making process.

When preparation of nonwoven fabrics is carried out by the wet paper making method, there may be used a cylinder paper machine, a fourdrinier paper machine, a short-wire paper machine, an inclined type paper machine, an inclined short-wire type paper machine, or a combination paper machine comprising the same or different kinds of the paper machines mentioned above in combination. As water, ion-exchanged water or distilled water is preferably used. A dispersant, a thickener or others, which likely impacts an effect on the characteristics of electrochemical elements, shall not be added as little as possible, but a suitable amount of them may be used. In such a case, nonionic one is preferably used.

A basis weight of the whole heat-resistant nonwoven fabric of the present invention is not particularly limited, and preferably 5 g/m² to 100 g/m², more preferably 8 g/m² to 50 g/m². A thickness of the whole heat-resistant nonwoven fabric of the present invention is not particularly limited, and as a thickness which provides high uniformity, 10 μm to 300 μm is preferred, and 20 μm to 150 μm is more preferred. If it is less than 10 μm, sufficient puncture strength can be hardly obtained, while if it is thicker than 300 μm, for example, a surface area of electrodes to be contained in an electrochemical element such as a secondary battery or an electric double layer capacitor, etc. becomes small, so that capacity of the electrochemical element becomes small.

### <Fibrillated Heat Resistant Fiber 1>

Para series wholly aromatic polyamide (available from Teijin Techno Products Limited, TWARON 1080, trade name, fineness: 1.2 dtex, fiber length: 3 mm) was dispersed in water so as to have an initial concentration of 5% by weight. Beating treatment was repeated 15 times by using a double disc refiner to prepare a fibrillated para series wholly aromatic polyamide fiber having a weight average fiber length of 1.55 mm. In the following, this is designated to as fibrillated heat resistant fiber 1 or FB1.

### <Fibrillated Heat Resistant Fiber 2>

The fibrillated heat resistant fiber 1 was subjected to beating treatment by using a high-pressure homogenizer under the conditions of 500 kg/cm² repeatedly for 25 times to prepare a fibrillated para series wholly aromatic polyamide fiber having a weight average fiber length of 0.61 mm. In the following, this is designated to as fibrillated heat resistant fiber 2 or FB2.

### <Fibrillated Heat Resistant Fiber 3>

Wholly aromatic polyester (available from Kuraray, Co., Ltd., Vectran HHA, trade name, fineness: 1.7 dtex, fiber length: 3 mm) was dispersed into water so that an initial concentration became 5% by weight, beating treatment is carried out 15 times repeatedly by using a double disc refiner, and then, it is treated by using a high-pressure homogenizer under the conditions of 500 kg/cm² for 20 times repeatedly to prepare a fibrillated wholly aromatic polyester fiber having a weight average fiber length of 0.35 mm. In the following, this is designated to as fibrillated heat resistant fiber 3 or FB3.

### <Fibrillated Heat Resistant Fiber 4>

PBO fiber (available from TOYOBO Co., Ltd., Zylon AS, trade name, fineness: 1.7 dtex, fineness: 2 dtex, fiber length: 3 mm) was dispersed into water so that an initial concentration became 5% by weight, beating treatment is carried out 25 times repeatedly by using a double disc refiner, and then, it is treated by using a high-pressure homogenizer under the conditions of 500 kg/cm² for 20 times repeatedly to prepare a fibrillated PBO fiber having a weight average fiber length of 0.58 mm. In the following, this is designated to as fibrillated heat resistant fiber 4 or FB4.

### <Fibrillated Cellulose Fiber 1>

Linter was dispersed in deionized water so that an initial concentration became 5% by weight, and treated 20 times repeatedly by using a high-pressure homogenizer with a pressure of 500 kg/cm² to prepare a fibrillated cellulose fiber 1 having a weight average fiber length of 0.33 mm. In the following, this is designated to as fibrillated cellulose fiber 1 or FBC1.

### <Preparation of Slurry>

A heat resistant slurry for forming a heat resistant layer and an anti-oxidative slurry for forming an anti-oxidative layer were prepared by using a pulper with the starting materials and contents thereof as shown in Table 1. At this time, deionized water was used.

“PET1” in Table 1 means a polyethylene terephthalate fiber having a fineness of 0.1 dtex and a fiber length of 3 mm (available from TEIJIN LIMITED, TEIJIN TETORON TEPYRUS TM04PN SD0.1×3, trade name),

“PET2” means polyethylene terephthalate fiber having a fineness of 0.6 dtex and a fiber length of 5 mm (available from TEIJIN LIMITED, TEIJIN TETORON TA04N SD0.6×5, trade name),

“PET3” means core-shell complex fiber having a fineness of 1.7 dtex and a fiber length of 5 mm (available from TEIJIN LIMITED, TEIJIN TETORON TJ04CN SD1.7×5, trade name, core portion: polyethylene terephthalate having a melting point of 255° C., shell portion: a copolymerized polyester containing a polyethylene terephthalate component and a polyethylene isophthalate component, a melting point of 110° C.),

“PET4” means wholly aromatic polyester fiber having a fineness of 1.7 dtex and a fiber length of 5 mm (available from Kuraray, Co., Ltd., Vectran HHA, trade name).

“A1” means acrylic fiber having a fineness of 0.1 dtex and a fiber length of 3 mm (available from MITSUBISHI RAYON CO., LTD., Vonnel M.V.P, trade name, an acrylonitrile series copolymer comprising three components of acrylonitrile, methyl acrylate, and methacrylic acid derivative),

“PA1” means aromatic polyamide having a fiber fineness of 0.08 dtex and a fiber length of 3 mm (available from Kuraray, Co., Ltd., Genestar, trade name, a melting point of 255° C., a softening point of 230° C.),

“PA2” means para series wholly aromatic polyamide fiber having a fineness of 1.2 dtex and a fiber length of 5 mm (available from Teijin Techno Products Limited, Technora, trade name),

“PBO1” means PBO fiber having a fineness of 1.7 dtex and a fiber length of 5 mm, available from TOYOBO CO., LTD., ZYLON AS, trade name).

TABLE 1

| | Starting material, content |
|---|---|
| | (% by weight) |
| Heat resistant | |
| slurry | |
| 1 | FB1/PA1 = 50/50 |
| 2 | FB1/PET1/FBC1 = 70/20/10 |
| 3 | FB1/PA2/FBC1 = 50/45/5 |
| 4 | FB1/PET1/PA2/PET3 = 30/20/30/20 |
| 5 | FB2/PA1/PA2/FBC1 = 50/20/20/10 |
| 6 | FB2/A1/FBC1 = 32/58/10 |
| 7 | FB2/PA1/PET3 = 50/20/30 |
| 8 | FB3/PET2/PET3 = 60/20/20 |
| 9 | FB3/PET1/PET4/FBC1 = 40/20/30/10 |
| 10 | FB3/PET1/FBC1 = 50/30/20 |
| 11 | FB4/A1/FBC1 = 60/30/10 |
| 12 | FB4/PBO1 = 50/50 |
| 13 | FB4/PA1/PBO1/FBC1 = 70/10/10/10 |
| 14 | PA2/PET1/PET3/FBC1 = 50/25/20/5 |
| 15 | PA2/PET1/PET3 = 50/20/30 |
| 16 | PET1/PET3/PET4 = 30/20/50 |
| Anti- | |
| oxidative | |
| slurry | |
| 1 | PET1/FBC1 = 90/10 |
| 2 | A1/FBC1 = 90/10 |
| 3 | FB3/PET1/FBC1 = 50/40/10 |
| 4 | FB3/PET4/FBC1 = 50/30/20 |

In the following, the present invention is explained in more detail by referring to Examples, but the present invention is not limited by these Examples.

### Examples 1 to 16

As shown in Table 2, a heat resistant slurry and an anti-oxidative slurry were each flown to respective predetermined paper making machines, and subjected to wet paper making with predetermined basis weights to prepare heat-resistant nonwoven fabrics 1 to 3, 6 to 9, 11 to 13 each comprising a layer having heat resistance and a layer having anti-oxidative property. Also, heat-resistant nonwoven fabrics 4, 5, 10, 14 to 16 each comprising a layer having heat resistance and a layer having both of heat resistance and an anti-oxidative property in combination were prepared. A whole density of the heat-resistant nonwoven fabrics 1 to 16 was 0.5 g/cm³ respectively. In the following tables, “Cylinder” means a cylinder paper machine, “Inclined” means an inclined type paper machine, and “Inclined short-wire” means an inclined short-wire type paper machine.

### Comparative Examples 1 to 3)

As shown in Table 2, a heat resistant slurry or an anti-oxidative slurry was flown to respective predetermined paper making machines, and subjected to wet paper making with predetermined basis weights to prepare nonwoven fabrics 17 and 18 having a heat resistant layer alone with a density of 0.5 g/cm³, and a nonwoven fabric 19 having an anti-oxidative layer alone with a density of 0.5 g/cm³.

### <Preparation of Electric Double Layer Capacitors 1 to 16>

85% by weight of activated carbon having an average particle size of 6 μm as an electrode active substance, 7% by weight of carbon black as a conductive material, and 8% by weight of a polytetrafluoroethylene as a binder were mixed and kneaded to prepare a sheet-shaped electrode with a thickness of 0.2 mm. This was adhered to the both surfaces of an aluminum foil with a thickness of 50 μm by using a conductive adhesive, and extended by applying a pressure to prepare an electrode. This electrode was used as a negative electrode and a positive electrode. The heat-resistant nonwoven fabrics 1 to 16 were each laminated by interposing between the negative electrode and the positive electrode, and wound to a spiral shape by using a winding machine to prepare spiral type elements. At this time, the layer having an anti-oxidative property was positioned at the surface contacting with the positive electrode. Heat-resistant nonwoven fabrics were each provided at the both outermost layers at the positive electrode side and the negative electrode side. This spiral type element was contained in a case made of aluminum, to a positive electrode terminal and a negative electrode terminal attached to the case were welded a positive electrode lead and a negative electrode lead, and the case was sealed except for an electrolyte pouring port. The whole case was subjected to heat treatment at 250° C. for 50 hours to remove water component contained in the electrodes and the heat-resistant nonwoven fabric. This was allowed to cool to room temperature, and then, an electrolyte was poured into the case, and the pouring port was closed to prepare electric double layer capacitors 1 to 16, respectively. As the electrolyte, a solution of 1.5 mol/l of (C₂H₅)₃(CH₃)NBF₄ dissolved in propylene carbonate was used.

### <Preparation of Electric Double Layer Capacitors 17 to 19>

Electric double layer capacitors 17 to 19 were prepared in the same manner as in the preparation of the electric double layer capacitors 1 to 16 except for using the nonwoven fabrics 17 to 19 in place of the heat-resistant nonwoven fabric.

With regard to the heat-resistant nonwoven fabrics 1 to 16, the nonwoven fabrics 17 to 19 and the electric double layer capacitors 1 to 19, their properties were measured according to the following test methods, and the results are shown in Tables 3 to 4.

### <Puncture Strength>

The heat-resistant nonwoven fabrics 1 to 16 and nonwoven fabrics 17 to 19 were cut to an optional size with a width of 50 mm or more and a length of 200 mm or more to prepare samples. They were placed in a thermostatic dryer (manufactured by YAMATO SCIENTIFIC Co., Ltd., DHS82), and subjected to heat treatment at 250° C. for 50 hours. Thereafter, they were all cut to stripe shape with a width of 50 mm. A metal needle (manufactured by ORIENTEC Co., Ltd.) having a rounded tip (curvature 1.6) and a diameter of 1 mm was mounted on a table type material tester (manufactured by ORIENTEC Co., Ltd., STA-1150), and moved vertically downward to the surface of the sample at a constant speed of 1 mm/s until it passes the sample. The maximum load (N) at this time was measured, and this was a puncture strength. The puncture strength was measured at 5 or more spots per one sample, and the lowest puncture strength value among the whole measured values was shown in Table 3.

### <Failure Ratio>

Resistance values of each 100 samples of the electric double layer capacitors 1 to 19 were measured, and an internal short-circuit failure ratio per 100 samples was calculated and shown in Table 3.

### <Anti-Oxidative Property>

To electric double layer capacitors 1 to 19 was applied a voltage of 2.7V for 72 hours continuously, and then, the heat-resistant nonwoven fabric and the nonwoven fabric were taken out from the capacitors. The heat-resistant nonwoven fabric surface and the nonwoven fabric surface which had been contacted with the positive electrode were washed with methanol, and then, infrared absorption spectrum was observed. A wave number (A) of an absorption band which showed the maximum absorbance in the region of 500 cm⁻¹ to 3000 cm⁻¹ was each confirmed before and after applying the voltage. When the position of (A) has been changed after applying the voltage, it was described as “changed” in Table 4, while when change was not occurred, then it was described as “no change” in the table, and the wave number (A) which showed the maximum absorbance was also shown. A rate of change ((C−D)/C) (%) was calculated, wherein

(C) is a ratio of an absorbance at the absorption band (A) before applying the voltage to an absorbance at a wave number (B) before applying the voltage, and
(D) is a ratio of an absorbance at the absorption band (A) after applying the voltage to an absorbance at a wave number (B) after applying the voltage. Wave numbers (A) and (B) of the absorption bands used for the calculation and the absolute values of the rate of change were shown in Table 4.

### <Characteristics Maintaining Ratio>

To the electric double layer capacitors 1 to 19 was applied a voltage of 2.7V at 70° C. for 1000 hours continuously, and then an electrostatic capacity thereof was measured. A rate (%) of the measured electrostatic capacity to an initial electrostatic capacity, i.e., an electrostatic capacity retaining rate was obtained, which is made a characteristics maintaining ratio, and shown in Table 4. The larger the value is, the longer the lifetime is and the more preferred it is.

TABLE 2

| | | Paper- | Basis | | Paper- | Basis |
|---|---|---|---|---|---|---|
| | Heat resistant | making | weight | Antioxidative | making | weight |
| Example | slurry | machine | g/m² | slurry | machine | g/m² |
| Example 1 | 1 | Cylinder | 20 | 1 | Cylinder | 10 |
| Example 2 | 2 | Inclined | 20 | 1 | Cylinder | 15 |
| Example 3 | 3 | Inclined | 25 | 2 | Cylinder | 10 |
| Example 4 | 4 | Inclined | 20 | 3 | Inclined | 10 |
| | | | | | short-wire | |
| Example 5 | 5 | Cylinder | 15 | 4 | Inclined | 15 |
| Example 6 | 6 | Inclined | 20 | 2 | Cylinder | 10 |
| Example 7 | 7 | Cylinder | 20 | 2 | Cylinder | 10 |
| Example 8 | 8 | Inclined | 20 | 1 | Cylinder | 10 |
| Example 9 | 9 | Inclined | 20 | 1 | Cylinder | 10 |
| Example 10 | 10 | Cylinder | 10 | 3 | Inclined | 10 |
| | | | | | short-wire | |
| Example 11 | 11 | Cylinder | 15 | 2 | Cylinder | 15 |
| Example 12 | 12 | Cylinder | 20 | 1 | Cylinder | 10 |
| Example 13 | 13 | Inclined | 20 | 1 | Cylinder | 10 |
| Example 14 | 14 | Cylinder | 15 | 4 | Inclined | 15 |
| Example 15 | 15 | Cylinder | 20 | 3 | Inclined | 10 |
| | | | | | short-wire | |
| Example 16 | 16 | Cylinder | 10 | 3 | Inclined | 20 |
| | | | | | short-wire | |
| Comparative | 3 | Inclined | 30 | None | None | None |
| example 1 | | | | | | |
| Comparative | 7 | Cylinder | 30 | None | None | None |
| example 2 | | | | | | |
| Comparative | None | None | None | 1 | Cylinder | 30 |
| example 3 | | | | | | |

TABLE 3

| | Puncture | Failure |
|---|---|---|
| | strength | ratio |
| Example | N | % |
| Example 1 | 0.8 | 15 |
| Example 2 | 0.9 | 15 |
| Example 3 | 2.5 | 5 |
| Example 4 | 0.5 | 30 |
| Example 5 | 1.7 | 8 |
| Example 6 | 2.3 | 6 |
| Example 7 | 0.7 | 18 |
| Example 8 | 0.6 | 24 |
| Example 9 | 1.5 | 10 |
| Example 10 | 0.5 | 30 |
| Example 11 | 1.0 | 14 |
| Example 12 | 1.2 | 12 |
| Example 13 | 0.8 | 15 |
| Example 14 | 1.6 | 9 |
| Example 15 | 1.1 | 12 |
| Example 16 | 0.8 | 15 |
| Comparative | 1.9 | 9 |
| example 1 | | |
| Comparative | 0.8 | 17 |
| example 2 | | |
| Comparative | 0.4 | 56 |
| example 3 | | |

TABLE 4

| | Anti- | | |
|---|---|---|---|
| | oxidative | Anti- | |
| | property | oxidative | Character- |
| | Maximum | property | istics |
| | absorbance | (A)/(B) | maintaining |
| | wave number | changed rate | ratio |
| Example | (A) cm⁻¹ | (D) % | % |
| Example 1 | No change | 1709/1339 | 92 |
| | 1709 | 12.6 | |
| Example 2 | No change | 1709/1339 | 92 |
| | 1709 | 12.5 | |
| Example 3 | No change | 2237/1063 | 87 |
| | 2237 | 15.3 | |
| Example 4 | No change | 1711/1339 | 90 |
| | 1711 | 13.8 | |
| Example 5 | No change | 1711/1339 | 84 |
| | 1711 | 23.7 | |
| Example 6 | No change | 2237/1063 | 88 |
| | 2237 | 15.2 | |
| Example 7 | No change | 2237/1063 | 86 |
| | 2237 | 15.5 | |
| Example 8 | No change | 1709/1339 | 92 |
| | 1709 | 12.6 | |
| Example 9 | No change | 1709/1339 | 92 |
| | 1709 | 12.5 | |
| Example 10 | No change | 1711/1339 | 91 |
| | 1711 | 13.6 | |
| Example 11 | No change | 2237/1063 | 88 |
| | 2237 | 15.0 | |
| Example 12 | No change | 1709/1339 | 92 |
| | 1709 | 12.7 | |
| Example 13 | No change | 1709/1339 | 92 |
| | 1709 | 12.6 | |
| Example 14 | No change | 1711/1339 | 84 |
| | 1711 | 24.5 | |
| Example 15 | No change | 1711/1339 | 90 |
| | 1711 | 13.6 | |
| Example 16 | No change | 1711/1339 | 90 |
| | 1711 | 13.5 | |
| Comparative | Changed | 722/1046 | 45 |
| example 1 | | 78.9 | |
| Comparative | Changed | 1241/724 | 62 |
| example 2 | | 42.0 | |
| Comparative | No change | 1709/1339 | 92 |
| example 3 | 1709 | 12.5 | |

As shown in Table 3, the heat-resistant nonwoven fabrics prepared in Examples 1 to 16 had puncture strength of 0.5N or more after heat treatment at 250° C. for 50 hours, so that failure ratio of the electric double layer capacitors was low whereby they are excellent. Also, as shown in Table 4, since the heat-resistant nonwoven fabrics of Examples 1 to 16 have a layer having an anti-oxidative property, the fabrics at the positive electrode side were not deteriorated due to oxidation, a characteristics maintaining ratio of the electric double layer capacitors was high, whereby the fabrics showed high reliability.

On the other hand, since the nonwoven fabrics prepared in Comparative examples 1 and 2 comprise only a layer having heat resistance, puncture strength after heat treatment was strong, and a failure ratio was low. However, since the nonwoven fabrics of Comparative examples 1 and 2 do not have a layer having an anti-oxidative property, deterioration of the nonwoven fabrics at the positive electrode side due to oxidation was significant, and the characteristics maintaining rate of the electric double layer capacitor was poor.

The nonwoven fabric prepared in Comparative example 3 was excellent in a maintaining rate of characteristics since it has a layer having an anti-oxidative property. However, the nonwoven fabric of Comparative example 3 does not have a layer having heat resistance, puncture strength of the nonwoven fabric after heat treatment at 250° C. for 50 hours was weak, and a failure ratio of the electric double layer capacitor was high.

### UTILIZABILITY IN INDUSTRY

The heat-resistant nonwoven fabrics of the present invention comprise a layer having heat resistance and a layer having an anti-oxidative property (the layer having an anti-oxidative property includes a layer having both of heat resistance and an anti-oxidative property in combination), so that they have large puncture strength after high temperature heat treatment or after reflow, thereby difficultly causing damage or breakage due to external pressure or impact. In addition, they have a layer having an anti-oxidative property so that they can endure high voltage.

As an application example of the present invention, there may be mentioned a use in which both characteristics of heat resistance and an anti-oxidative property are required, for example, a separator for an electric double layer capacitor, an electrolytic capacitor, a lithium ion battery and the like.

1. A method of separating a positive electrode from a negative electrode in a high-voltage electrochemical device, which method comprises the steps of:
providing a heat-resistant nonwoven fabric used as a separator for electrochemical elements including negative and positive electrodes, said heat-resistant nonwoven fabric comprising:
a heat resistant layer, adapted to be contacted with a negative electrode of the electrochemical elements, comprising 50 to 100% by weight of at least one member selected from the group consisting of wholly aromatic polyamide, wholly aromatic polyester amide, wholly aromatic polyether, wholly aromatic polycarbonate, wholly aromatic polyazomethine, polyphenylene sulfide, polybenzimidazole, polyamideimide, and polyimide fibers; and
an anti-oxidative layer, adapted to be contacted with a positive electrode of the electrochemical elements, comprising 80 to 100% by weight of at least one anti-oxidative fiber selected from the group consisting of polyethylene terephthalate, polybutylene terephthalate, wholly aromatic polyester, polyolefin, acrylonitrile, acrylonitrile derivative, polytetrafluoroethylene, polyetherether ketone, poly-p-phenylenebenzobisthiazole and poly-p-phenylene-2,6-benzobisoxazole fibers,
wherein:
said heat-resistant nonwoven fabric has a basis weight of 5 to 100 g/m² and a thickness of from 10 to 300·m, and said heat-resistant nonwoven fabric has a puncture strength of 0.5 N or more after heat treatment at 250° C. for 50 hours; and
a position of an absorption band (A) showing a maximum infrared absorbance in the region of 500 cm⁻¹ to 3000 cm⁻¹ of the layer having an anti-oxidative property does not change before and after applying a voltage of 2.7V for 72 hours, and
an absolute value of a rate of change ((C−D)/C) is less than 25%, wherein
(C) is a ratio of the absorbance at the absorption band (A) before applying the voltage to an absorbance at a wave number (B) before applying the voltage, and
(D) is a ratio of the absorbance at the absorption band (A) after applying the voltage to an absorbance at a wave number (B) after applying the voltage,
wherein the wave number (B) is a wave number of a specific absorption peak among independent absorption peaks other than an absorption peak branched from the absorption band (A) or a shoulder peak, the specific absorption peak being successively selected from a wave number of an independent absorption peak having a larger absorbance among the group of said independent absorption peaks;
contacting said negative electrode with said heat-resistant layer in said fabric; and
contacting said positive electrode with said anti-oxidative layer in said fabric.

2. The method according to claim 1, wherein the anti-oxidative layer is a layer having a heat resistance property in addition to the anti-oxidative property,
wherein the layer having a heat resistance property in addition to the anti-oxidative property contains a fiber having both of a heat resistance property and an anti-oxidative property, being at least one member selected from the group consisting of wholly aromatic polyester, polytetrafluoroethylene, polyetherether ketone, poly-p-phenylenebenzobisthiazole, and poly-p-phenylene-2,6-benzobisoxazole,
wherein an amount of the fiber having both of a heat resistance property and an anti-oxidative property is 80 to 100% by weight based on the whole amount of the layer having a heat resistance property in addition to the anti-oxidative property.

3. The method according to claim 1, wherein at least part of the heat resistant fiber is fibrillated to a fiber diameter of 1 μm or less.

4. The method according to claim 1, wherein the wholly aromatic polyamide is at least one member selected from the group consisting of poly(para [symbol] phenylenetelephthalamide), poly(parabenzamide), poly(para [symbol] amide hydrazide), poly(paraphenylenetelephthalamide-3,4-diphenyl ether telephthalamide), poly(4,4′-benzanilide telephthalamide), poly(paraphenylene-4,4′-biphenylene [symbol] dicarboxylic acid amide), poly(paraphenylene-2,6-naphtha [symbol] lene dicarboxylic acid amide), poly(2-chloro-p-phenylene [symbol] telephthalamide) and copolyparaphenylene-3,4′-oxydiphenyl [symbol] enetelephthalamide.

5. The method according to claim 1, wherein a basis weight of the heat-resistant nonwoven fabric is 8 g/m² to 50 g/m².

6. The method according to claim 1, wherein a thickness of the heat-resistant nonwoven fabric is 20 μm to 150 μm.
